(19) United States
(12) Patent Application Publication
(10) Pub. No.: US 2025/0166527 A1
(43) Pub. Date: May 22, 2025

(54) Canine Stifle Teaching Model and Method of Manufacture

(71) Applicant: Lincoln Memorial University, Harrogate, TN (US)

(72) Inventor: Robert Gilley, Harrogate, TN (US)

(73) Assignee: Lincoln Memorial University, Harrogate, TN (US)

(21) Appl. No.: 18/913,006

(22) Filed: Oct. 11, 2024

Related U.S. Application Data
(60) Provisional application No. 63/543,663, filed on Oct. 11, 2023.

(51) Int. Cl. G09B 23/36

(52) U.S. Cl. CPC G09B 23/36

(57) ABSTRACT

A canine stifle teaching model is provided that includes a tibia member, a fibula member, and a femur member assembled in anatomical spatial relationship to one another. A plurality of ligament members extend among the tibia member, fibula member, and femur member to restrain the tibia member, fibula member, and femur member in the anatomical spatial relationship. An adjustment mechanism is configured for selective adjustment to loosen and tighten at least one of the plurality of ligament members.

### CROSS-REFERENCE TO RELATED APPLICATIONS

This application claims the benefit of U.S. Provisional Patent Application Ser. No. 63/543,663, filed on Oct. 11, 2023, the content of which is incorporated herein in its entirety by reference.

### STATEMENT REGARDING FEDERALLY SPONSORED RESEARCH OR DEVELOPMENT

Not Applicable.

### FIELD OF INVENTION

The present general inventive concept pertains to veterinary medical teaching apparatus, and more particularly to a canine stifle teaching model for teaching a student to assess cranial cruciate ligament stability.

### BACKGROUND

In the field of veterinary medicine, it is often desirable for students to observe a condition of an animal in order to gain better understanding of the effects of a given condition on an animal's health or anatomy. For example, in the field of canine veterinary medicine, a tear or rupture of the cranial cruciate ligament (hereinafter referred to as a “RCCL”) is a common canine orthopedic malady which occurs in the rear central leg joint, or “stifle,” of the animal (corresponding to the “knee” of a human).

The presence of a RCCL in a canine patient is typically diagnosed by performing a “cranial drawer test,” which is a physical test designed to elicit a “cranial drawer sign” from the stifle of the canine patient. The procedure for performing a cranial drawer test involves standing behind the canine patient, placing a thumb on the caudal aspect of the femoral condylar region on the lateral fabella of the patient, and placing an index finger on the patella of the patient. Another thumb is placed on the head of the fibula, and an index finger is placed on the tibial crest. In this position, a firm cranially directed force may be applied to the tibia with one hand while keeping the femur fixed with the other hand. For a canine patient with RCCL, this should elicit a “positive” cranial drawer sign, which is when the proximal tibia slides unrestrained in a cranial direction with respect to the distal femur.

Because the diagnostic test for RCCL in canines involves physical manipulation of the canine's stifle and observation of movement therein, it is often helpful in teaching students how to test for and diagnose RCCL in canines for the students to observe a case of RCCL on a patient animal and, if possible, actually perform a cranial drawer test to elicit a cranial drawer sign from the stifle of the animal exhibiting RCCL. However, in many instances, the availability of live patient animals with stifles exhibiting RCCL is limited. For example, in a teaching veterinary clinic or hospital setting, the availability of live patient animals with stifles exhibiting RCCL may be dependent upon the caseload of the teacher and/or teaching institution. If no patient animal exhibiting RCCL is available when a student is to be taught, the student may not be afforded the opportunity to observe RCCL in a live patient animal or to perform a cranial drawer test and elicit a positive cranial drawer sign in a live patient animal. Furthermore, even if a live patient animal exhibiting RCCL is available, eliciting a positive cranial drawer sign of the animal's stifle upon examination of the animal can cause discomfort to the patient, especially if performed incorrectly.

While it is possible to use live animals that present clinically with RCCL in a hospital setting to demonstrate a RCCL injury, such practice is often looked upon unfavorably and is generally undesirable for a number of reasons. For example, the performance of a cranial drawer test on a live, clinically affected animal to elicit a cranial drawer sign in order to demonstrate and diagnose a RCCL injury often causes pain to the animal. If done repeatedly for teaching purposes beyond the need for diagnosis, there are ethical concerns regarding subjecting an animal to excessive and unnecessarily painful procedures.

The use of simulated teaching models designed to resemble a portion of an animal patient offers a benign, perpetually available method of teaching students to evaluate stifle stability. However, in the known prior art, a significant limitation exists in that an anatomically accurate teaching model of a stifle portion of a canine patient that can reliably and repeatedly be modified to exhibit, or not exhibit, a RCCL condition has heretofore not been developed. Accordingly, there exists a desire to produce a simulated and anatomically accurate teaching model of a stifle portion of a canine patient that exhibits features and observable symptoms consistent with RCCL. There further exists a desire to produce a simulated and anatomically accurate teaching model of a stifle portion of a canine patient that can be adjusted between exhibiting symptoms consistent with RCCL and exhibiting symptoms consistent with a normal, healthy stifle. There further exists a desire to produce an adjustable teaching model of a stifle as described above wherein the severity of the symptoms of RCCL exhibited in the stifle are adjustable, such that the stifle may be adjusted to exhibit a range of cranial drawer sign consistent with a range of RCCL varying in severity of from a “slight” RCCL to a “severe” RCCL.

### BRIEF SUMMARY OF THE INVENTION

According to various example embodiments of the present general inventive concept, an animal stifle teaching model is provided that includes a tibia member, a fibula member, and a femur member assembled in anatomical spatial relationship to one another. Various example embodiments of the present general inventive concept may also include a plurality of ligament members extending among the tibia member, fibula member, and femur member to restrain the tibia member, fibula member, and femur member in the anatomical spatial relationship. In various example embodiments, an adjustment mechanism may be configured for selective adjustment to loosen and tighten at least one of the plurality of ligament members.

The foregoing and/or other aspects and advantages of the present general inventive concept may be achieved by providing an adjustment mechanism that comprises a cord extending from a first one of the tibia member and the femur member and secured to a second one of the tibia member and the femur member. Certain aspects and advantages of the present general inventive concept may be achieved through the adjustment mechanism further comprising a tightening device secured in relation to the tibia member or the femur member and configured to draw a portion of the cord toward the first one of the tibia member and the femur member.

In various example embodiments, the tightening device may comprise a first hub secured to the first one of the tibia member and the femur member, and a threaded shaft received within a threaded bore defined by the first hub. In various example embodiments, the tightening device may further comprise a swivel connector secured to an end of the threaded shaft and to an end of the cord opposite the second one of the tibia member and the femur member. The tibia member may, in various embodiments further include a menisci member fixed at a proximal end of the tibia member. In various embodiments, the cord may extend from the femur member and secured to the menisci member. In various embodiments, the tightening device may be at least partially disposed in a cavity defined by the femur member. In various embodiments, at least a portion of the cord may extend along a through bore defined between the cavity and a distal end of the femur member.

Various example embodiments of the present general inventive concept may be achieved in which the first hub of the tightening device is fixed in relation to the femur member within the cavity. In various embodiments, the tightening device may further comprise a second hub secured to the femur member within the cavity, the second hub defining a threaded bore in coaxial alignment with the threaded bore of the first hub. In various embodiments, the threaded shaft may be threadably received within both the threaded bore defined by the first hub and the threaded bore defined by the second hub. Thus, rotation of the threaded shaft in relation to the first and second hubs may result in translation of at least a portion of the cord toward or away from the distal end of the femur.

Various example embodiments of the present general inventive concept may be achieved in which the threaded shaft extends along a long dimension of the femur member. In various embodiments, the tightening device may further comprise a handle fixed along a portion of the threaded shaft and configured to permit rotation of the threaded shaft in relation to the first and second hubs. In various embodiments, the handle may comprise at least one wheel extending in a plane orthogonal to a central axis of the threaded shaft.

The foregoing and/or other aspects and advantages of the present general inventive concept may be achieved by providing a patella member disposed along a front side of the femur member proximate an interface between the distal end of the femur and the proximal end of the tibia member. In various embodiments, a first artificial ligament may be provided at least partially securing the patella member in relation to the femur member. In various embodiments, the first artificial ligament may further at least partially secure the patella member in relation to the tibia member. In various embodiments, a second artificial ligament may be provided at least partially securing a medial side of the femur member in relation to a medial side of the tibia member. In various embodiments, a third artificial ligament may be provided at least partially securing a lateral side of the femur member in relation to a lateral side of the tibia member.

Additional aspects and advantages of the present general inventive concept will be set forth in part in the description which follows, and, in part, will be obvious from the description, or may be learned by practice of the present general inventive concept.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a perspective view of a canine stifle teaching model according to an example embodiment of the present general inventive concept;

FIG. 2 illustrates a partial side view of the canine stifle teaching model of FIG. 1, showing a portion of the thigh muscle portion cut away to reveal portions of the adjustable connection;

FIG. 3 illustrates a partially exploded view of portions of the canine stifle teaching model of FIG. 1;

FIG. 4 illustrates an exploded view of the adjustable connection portion of the canine stifle teaching model of FIG. 1;

FIG. 5 illustrates a partial side view showing the interface of the femur member and tibia member portions of the canine stifle teaching model of FIG. 1;

FIG. 6 illustrates a partial front view showing the interface of the femur member and tibia member portions of the canine stifle teaching model of FIG. 1;

FIGS. 7A-7C illustrate portions of a method of manufacturing a canine stifle teaching model according to another example embodiment of the present general inventive concept;

FIG. 8 illustrates additional portions of a method of manufacturing a canine stifle teaching model according to one example embodiment of the present general inventive concept; and

FIG. 9 illustrates a partial front view showing the interface of the femur member and tibia member portions of a canine stifle teaching model and illustrating additional portions of a method of manufacturing a canine stifle teaching model according to one example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures. The following description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a canine stifle teaching model and method of manufacture are provided that allow for the provision of an artificial canine stifle that bears close resemblance, both in shape and feel, to a natural canine stifle. In accordance with various features and aspects of the present general inventive concept, in several embodiments, the canine stifle teaching model can be selectively reconfigured between a “normal” configuration, in which the canine stifle teaching model bears close resemblance, both in shape and feel, to a natural, healthy canine stifle that does not exhibit RCCL; and a “RCCL” configuration, in which the canine stifle teaching model bears close resemblance, both in shape and feel, to a natural canine stifle that is exhibiting RCCL. In more discreet embodiments, the canine stifle teaching model may be adjusted along a range of configurations between the “normal” and “RCCL” configurations, such that the canine stifle teaching model may be made to bear resemblance to a natural canine stifle that is exhibiting one of a range of varying degrees of severity of RCCL, from a “slight” RCCL to a more “severe” RCCL.

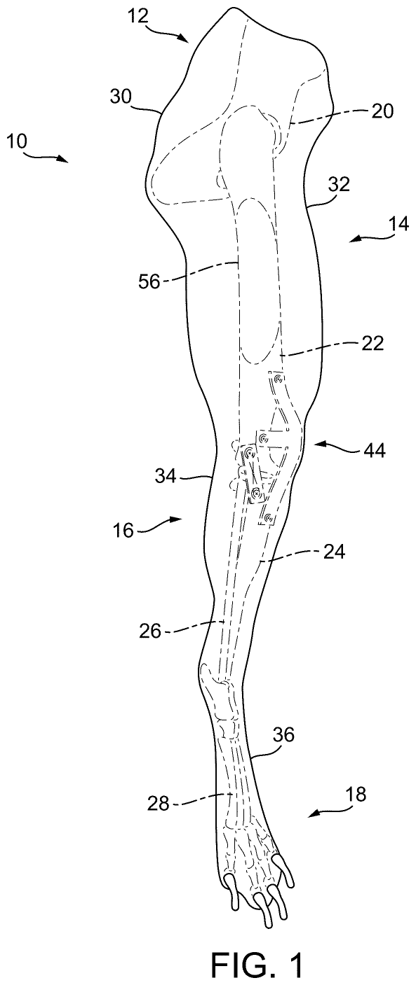

FIG. 1 illustrates one embodiment of a canine stifle teaching model constructed in accordance with several features of the present general inventive concept. With reference to FIG. 1, a canine stifle teaching model, or “stifle” 10 is provided defining generally a hip portion 12, a femoral portion 14, a tibial portion 16, and a metatarsal portion 18. The hip portion 12, femoral portion 14, tibial portion 16, and metatarsal portion 18 are shaped to resemble a natural hip, femoral region, tibial region, and metatarsal region, respectively, of a natural canine leg. The hip portion 12, femoral portion 14, tibial portion 16, and metatarsal portion 18 are further arranged in an end-to-end and connected fashion such that they cooperate to cause the overall stifle 10 to resemble the external shape of a canine's natural leg.

With reference to FIGS. 1-3, it can be seen that each of the various portions of the stifle 10 consist generally of an inner “bone” portion surrounded by an outer “flesh” portion. For example, in the illustrated embodiment, the hip portion 12 includes a substantially rigid hip member 20 having the general size, shape, and rigidity of at least a portion of a natural hip bone of a canine. The femoral portion 14 includes a substantially rigid femur member 22 having the general size, shape, and rigidity of a natural femur bone of a canine. The tibial portion 16 includes a substantially rigid tibia member 24 having the general size, shape, and rigidity of a natural tibia bone of a canine, as well as a substantially rigid fibula member 26 having the general size, shape, and rigidity of a natural tibia bone of a canine. The metatarsal portion 18 includes a plurality of substantially rigid metatarsal members 28, each having the general size, shape, and rigidity of one of the natural metatarsal bones of a canine. Generally, the hip member 20, femur member 22, tibia member 24, fibula member 26 and metatarsal members 28 are each arranged and oriented in relation to one another, and connected to one another in an end-to-end fashion, so as to correspond to the anatomical orientation of a hip bone, femur, tibia, fibula, and various metatarsals of a fully-articulated natural canine leg.

In the illustrated embodiment, each of the hip member 20, femur member 22, tibia member 24, fibula member 26 and metatarsal members 28 is formed from a substantially rigid synthetic material, such as for example polymer, plastic, resin, plaster, or the like. Thus, while in various embodiments the hip member 20, femur member 22, tibia member 24, fibula member 26 and metatarsal members 28 is each formed to resemble the approximate size, shape, weight, and rigidity of a real, natural bone of a canine leg, these components are merely synthetic replicas made to approximate the shape and characteristics of real bone and are not actually composed of natural canine bone. However, it will be recognized by one of skill in the art that, in certain embodiments, real, natural animal bone may be used to provide one or more of the hip member 20, femur member 22, tibia member 24, fibula member 26 and metatarsal members 28 without departing from the spirit and scope of the present general inventive concept.

In various embodiments, the outer “flesh” portions of the hip portion 12, femoral portion 14, tibial portion 16, and metatarsal portion 18 of the stifle 10 are also replicas which are made to resemble the approximate size, shape, weight, and texture of real, natural skin and muscle portions of a canine leg. For example, in the illustrated embodiment, the hip portion 12 includes a hip muscle portion 30 which at least partially surrounds the hip member 20. The hip muscle portion 30 is sized, shaped, and formed from one or more materials selected to resemble the muscular regions of a natural hip of a canine. Likewise, the femoral portion 14 includes a thigh muscle portion 32 surrounding the femur member 22 which is sized, shaped, and formed from one or more materials selected to resemble the muscular regions of a natural thigh of a canine. The tibial portion 16 includes a calf muscle portion 34 surrounding the tibia and fibula members 24, 26 which is sized, shaped, and formed from one or more materials selected to resemble the muscular regions of a natural calf portion of a canine. The metatarsal portion 18 includes a foot portion 36 which is sized, shaped, and formed from one or more materials selected to resemble the muscular regions of natural foot and paw portions of a canine. In various embodiments, each of the hip muscle portion 30, thigh muscle portion 32, calf muscle portion 34 and foot portion 36 is formed from one or more substantially flexible and resilient materials, such as for example one or more layers of flexible polymer foam rubber, silicon rubber, or the like. Thus, the hip muscle portion 30, thigh muscle portion 32, calf muscle portion 34 and foot portion 36 exhibit a general weight, shape, resilience, and “feel” approximating that of the corresponding muscle and skin portions of a natural canine leg. In the illustrated embodiment, at least portions of the hip muscle portion 30, thigh muscle portion 32, calf muscle portion 34 and foot portion 36 are integrally formed with one another, such that these outer portions of the stifle 10 cooperate with the various connections between the hip member 20, femur member 22, tibia member 24, fibula member 26 and metatarsal members 28 to hold and maintain the hip member 20, femur member 22, tibia member 24, fibula member 26 and metatarsal members 28 in the above-discussed end-to-end configuration resembling the natural shape of a canine leg.

By way of example, in one embodiment, each of the hip muscle portion 30, thigh muscle portion 32, calf muscle portion 34 and foot portion 36 comprises one or more replica muscles formed of flexible polymer foam, with each replica muscle being sized and shaped to resemble a corresponding muscle or muscle group of a natural canine leg. These replica muscles are each secured to a corresponding hip member 20, femur member 22, tibia member 24, fibula member 26 or metatarsal member 28 at locations corresponding to the anatomical locations of a fully-articulated natural canine leg. At least one encapsulation, such as for example cotton bandage, veterinary wrap, nylon fabric, or the like is provided encapsulating the various replica muscles and compressing the muscles to conform the replica muscles to their anatomical locations. Additionally, at least one layer of replica skin, such as for example silicone rubber, is provided covering the various replica muscles and encapsulation, thereby forming the outer layers of the hip muscle portion 30, thigh muscle portion 32, calf muscle portion 34 and foot portion 36. Those of skill in the art will recognize numerous other materials and configurations which may be used to form the hip muscle portion 30, thigh muscle portion 32, calf muscle portion 34 and foot portion 36, and such alternate materials and configurations may be used without departing from the spirit and scope of the present general inventive concept.

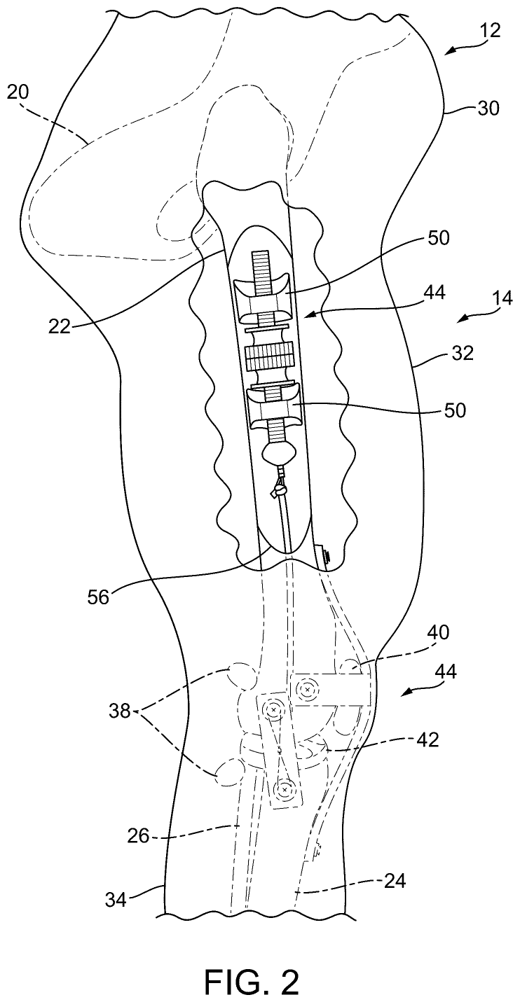

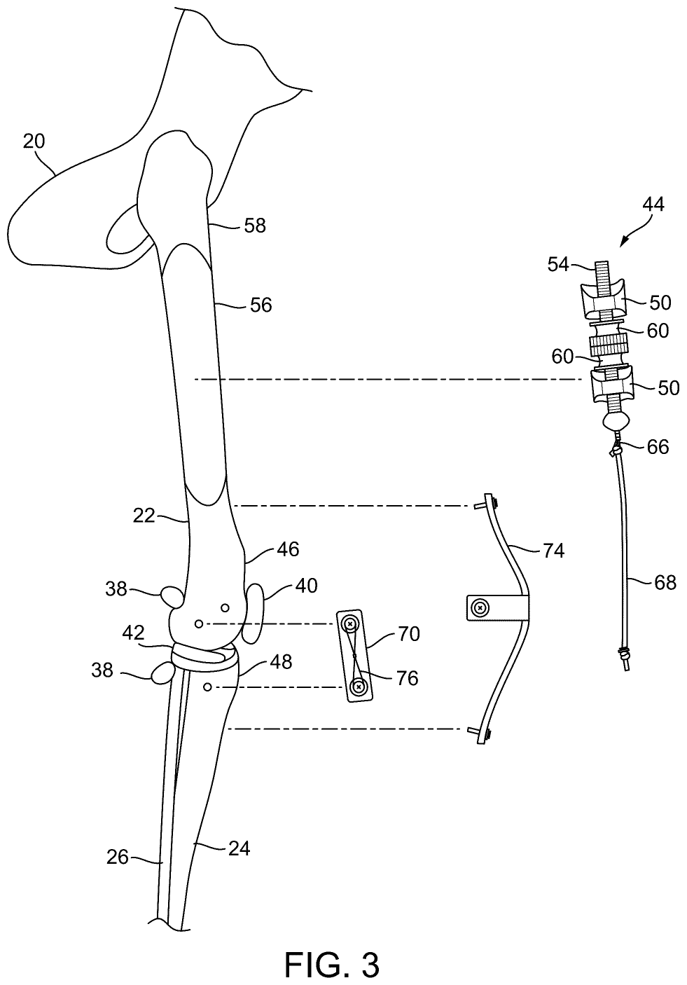

With reference to FIGS. 2 and 3, in the illustrated embodiment, additional fabella members 38, a patella member 40, and a menisci member 42 are provided at appropriate locations along the interface between the femur member 22 and tibia member 24 such that the fabella members 38, patella member 40, and menisci member 42 cooperate with the femur member 22 and tibia member 24 to provide a complete replica of the osteal anatomical components of the stifle portion of a natural canine leg. Specifically, the fabella members 38 are located at respective positions on rear sides of the femur member 22 and the fibula member 26 near the interface between the femur member 22 and the tibia member 24. The patella member 40 is located proximate the interface between the femur member 22 and the tibia member 24 on a front side thereof. The menisci member 42 is located along the proximal end of the tibia member 24, between the femur member 22 and the tibia member 24. It will be recognized that, in various embodiments, the fabella members 38, patella member 40, and menisci member 42 may each be provided as separate components. However, it will further be recognized that, in other embodiments, one or more of the fabella members 38, patella member 40, and menisci member 42 may be integrally formed with the adjacent femur member 22 or tibia member 24 so as to form a single member therewith.

In the illustrated embodiment, first and second artificial ligaments 70, 72 are provided connecting the femur member 22 and tibia member 24 at locations corresponding approximately to the medial and lateral collateral ligaments of a natural canine stifle. In various embodiments, each of the first and second artificial ligaments 70, 72 comprises an elongate, narrow strip of strong, flexible, and resilient material, such as for example silicon-coated nylon webbing, which is secured at opposite ends thereof to the femur member 22 and tibia member 24, respectively, by screw fasteners. In the illustrated embodiment, a polymer thread 76, such as for example fishing line, is provided extending between the screw fasteners of each of the first and second ligaments 70, 72 to provide additional reinforcement of the connection between the femur member 22 and tibia member 24. In the illustrated embodiment, the first artificial ligament 70 extends from a distal end of the femur member 22 to a proximal end of the tibia member 24 along a medial side of the femur member 22 and tibia member 24. Likewise, the second artificial ligament 72 extends from a distal end of the femur member 22 to a proximal end of the tibia member 24 along a lateral side of the femur member 22 and tibia member 24.

In the illustrated embodiment, an artificial tendon 74 is also provided, comprising a substantially cruciform-shaped piece of strong, flexible, and resilient material, such as the above-discussed silicone-coated nylon webbing, defining four elongated “ends” extending at substantially right angles to one another. The artificial tendon 74 is sized, shaped, and disposed along the femur member 22 and tibia member 24 to approximately correspond with, and to approximately replicate the connection provided by, the patellar ligament and the quadriceps tendon of a natural canine stifle. More specifically, in the illustrated embodiment, a first end of the artificial tendon 74 is connected to the front side of the femur member 22 proximal to the interface between the femur member 22 and the tibia member 24. An opposite second end of the artificial tendon 74 is connected to the front side of the tibia member 24 distal to the interface between the femur member 22 and the tibia member 24. A third end of the artificial tendon 74, extending substantially orthogonally to the first and second ends thereof, is connected to a medial side of the femur member 22 proximate to the interface between the femur member 22 and the tibia member 24, and a fourth end of the artificial tendon 74, extending substantially opposite the third end, is connected to a lateral side of the femur member 22 proximate to the interface between the femur member 22 and the tibia member 24. A central portion of the artificial tendon 74 overlies the patella member 40 on an opposite side of the patella member 40 from the interface between the femur member 22 and the tibia member 24, such that the artificial tendon 74 assists in securing and maintaining the patella member 40 in position proximate the interface between the femur member 22 and the tibia member 24.

In the illustrated embodiment, the thickness and flexibility of the material forming each of the first and second ligaments 77, 72 and the artificial tendon 74 is selected to exhibit a strength and flexibility approximating that of natural ligament and tendon found in a natural canine stifle. However, those of skill in the art will recognize numerous materials and design shapes which may be used to secure the femur member 22 and the tibia member 24 to one another and which provide a strong and slightly flexible connection similar in performance and feel to the natural ligaments and tendons found in a natural canine stifle. For example, in other embodiments, such materials as rubber, polymer, natural fabric, rope, or the like may be used. Those of skill in the art will recognize numerous materials and design shapes which may be used to fabricate the first and second ligaments 77, 72 and the artificial tendon 74, and such materials and design shapes may be used without departing from the spirit and scope of the present general inventive concept.

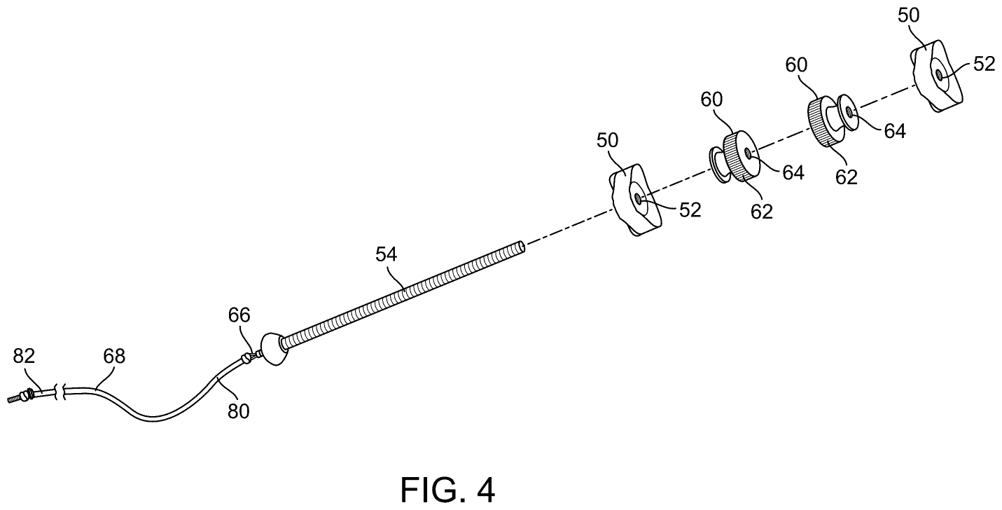

With further reference to FIGS. 2-6, in various embodiments, an adjustable connection 44 is provided to secure a distal end 46 of the femur member 22 to a proximal end 48 of the tibia member 24 in the above-discussed end-to-end configuration resembling the natural shape of a canine leg. As will be discussed hereinbelow, in accordance with several features of the present general inventive concept, the adjustable connection 44 is capable of being adjusted to draw the femur member distal end 46 and the tibia member proximal end 48 toward one another, or alternatively, to allow the femur member distal end 46 and the tibia member proximal end 48 to move away from one another. Thus, the stifle 10 may be adjusted between a first configuration, in which the distance between the femur member distal end 46 and the tibia member proximal end 48 is limited to within a range of separation resembling that of a healthy natural canine stifle, and a second configuration, in which the femur member distal end 46 is permitted to move in relation to the tibia member proximal end 48 to within a range of separation resembling that of a natural canine stifle exhibiting RCCL.

The adjustable connection 44 includes a pair of substantially stationary hubs 50, each defining a substantially cylindrical and internally-threaded through bore 52 therethrough. The hubs 50 are arranged in relation to one another such that the bores 52 thereof are in substantially coaxial alignment with one another. An externally-threaded rod 54 is provided having an outer diameter and thread characteristics such that the rod 54 may be threadably received within the two bores 52 of the hubs 50 in order to mount the rod 54 for linear translation along the central co-axis of the two bores 52. Stated differently, as the rod 54 is rotated about its long axis, the threaded engagement between the rod 54 and the bores 52 causes the rod 54 to be translated linearly along the central co-axis of the two bores 52.

In various embodiments, the hubs 50 are fixed in relation to either the femur member 22 or the tibia member 24. For example, in the illustrated embodiment, the femur member 22 defines a cavity 56 which is sized and shaped to receive the two hubs 50 and the rod 54 therein, with the central co-axis of the two bores 52 and the long axis of the rod 54 extending along a long dimension of the femur member 22 between a proximal end 58 and a distal end 46 of the femur member 22. The hubs 50 are fixed in relation to the femur member 22 within the cavity 56, and the cavity is of sufficient size and shape to allow the rod 54 to be translated linearly along the co-axis of the hub bores 52 between a first position, in which the rod 54 is translated toward the proximal end 58 of the femur member 22, and a second position, in which the rod 54 is translated toward the distal end 46 of the femur member 22. In various embodiments, the rod 54 may include one or more knobs, wheels, or other control mechanisms for allowing convenient and easy turning of the rod 54 about the long axis thereof, and thus, linear actuation of the rod 54 along the co-axis of the bores 52. For example, in the illustrated embodiment, a pair of lock wheels 60 are provided, with each lock wheel 60 defining a substantially cylindrical outer surface 62 having a tactile texture defined thereon, and a substantially cylindrical inner through bore 64 defining a threaded surface keyed to the outer threads of the rod 54. The lock wheels 60 are threadably received onto the rod 54 between the hubs 50 and are threadably compressed toward one another so as to lock the lock wheels 60 in a fixed relationship with one another and with the rod 54. Thus, rotation of one or both of the lock wheels 60 about the long axis of the rod 54 results in rotation of both lock wheels 60 and the rod 54 about the long axis of the rod 54. Thus, the lock wheels 60 may be used to manually “drive” the rod 54 in relation to the hubs 50 between the first and second positions.

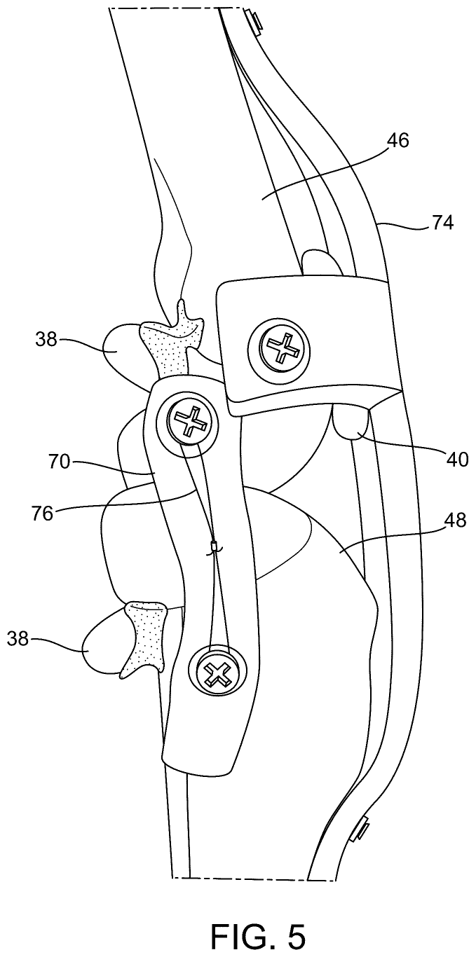

In the embodiment of FIGS. 3-6, a swivel connector 66 is provided secured in proximity to a distal end of the rod 54. A cord 68 is secured to the swivel connector 66 at a first end 80 thereof and extends through an opening between the cavity 56 and the femur member distal end 46. An opposite second end 82 of the cord 68 is secured to the proximal end 48 of the tibia member 24. (See FIG. 6.) In this configuration, the swivel connector 66 permits the cord 68 to rotate about a long dimension of the cord in relation to the long axis of the rod 54. Thus, by rotating the rod 54 to drive linear translation of the rod 54 along the long axis between the first and second positions, the cord 68 is drawn into and fed out from the opening between the cavity 56 and the femur member distal end 46 absent excessive twisting of the cord 68 in relation to the proximal end 48 of the tibia member 24. This allows the tibia member proximal end 48 and the femur member distal end 46 to be selectively drawn tighter toward one another and to be loosened in relation to one another through adjustment of the lock wheels 60 and associated linear translation of the rod 54.

In accordance with one embodiment of a method of use, the above-discussed stifle 10 may be provided in a first configuration, in which the adjustable connection 44 is tightened such that the tibia member proximal end 48 and the femur member distal end 46 are drawn toward one another to the point that the connection between the tibia member 24 and the femur member 22 resembles the range of movement and flexibility of a natural, healthy canine stifle. Optionally, in this first configuration, a cranial drawer test may be performed in which a user may elicit a cranial drawer response corresponding to a healthy canine stifle from the stifle 10. The adjustable connection 44 may be loosened to a second configuration in which the tibia member proximal end 48 and the femur member distal end 46 are partially released from one another to the point that the connection between the tibia member 24 and the femur member 22 resembles the range of movement and flexibility of a natural canine stifle exhibiting RCCL. A cranial drawer test may be performed in this second configuration, thus allowing a user to elicit a cranial drawer response from the stifle 10 corresponding to a canine stifle exhibiting RCCL. Optionally, the adjustable connection 44 may be adjusted to one or more additional configurations, wherein the tibia member proximal end 48 and the femur member distal end 46 are further released from one another, or drawn toward one another, to the point that the connection between the tibia member 24 and the femur member 22 resembles the range of movement and flexibility of a natural canine stifle exhibiting RCCL with greater or lesser severity. In this manner, a cranial drawer test may be performed in one or more of these additional configurations, thus allowing a user to elicit a cranial drawer response from the stifle 10 corresponding to a canine stifle exhibiting a range of RCCL's of varying severity.

Those of skill in the art will recognize numerous devices and configurations which may be used to achieve the adjustable connection 44, and such alternate devices and configurations may be used without departing from the spirit and scope of the present general inventive concept. For example, in one alternate embodiment, the adjustable connection 44 comprises a turnbuckle of the type having a central portion defining a clockwise-threaded through bore at one end thereof and a counterclockwise-threaded through bore at an opposite end thereof, with each of the two bores being in coaxial alignment with one another. Corresponding clockwise-threaded and counterclockwise-threaded shafts are provided in threaded mating engagement with the clockwise-threaded through bore and the counterclockwise-threaded through bore. Thus, turning the central portion of the turnbuckle in relation to either of the two threaded shafts results in the threaded shafts being drawn axially toward, or translated axially away from, each other. In this embodiment, one of the shafts is fixed within the cavity 56 near the proximal end of the femur member 22, and the other of the shafts is secured to the swivel connector 66. Thus, rotation of the turnbuckle central portion results in tightening or loosening of the connection between the tibia member proximal end 48 and the femur member distal end 46. Other suitable devices and configurations for drawing the tibia member proximal end 48 and the femur member distal end 46 nearer one another and for allowing these members to be partially loosened from one another will become apparent to one of skill in the art.

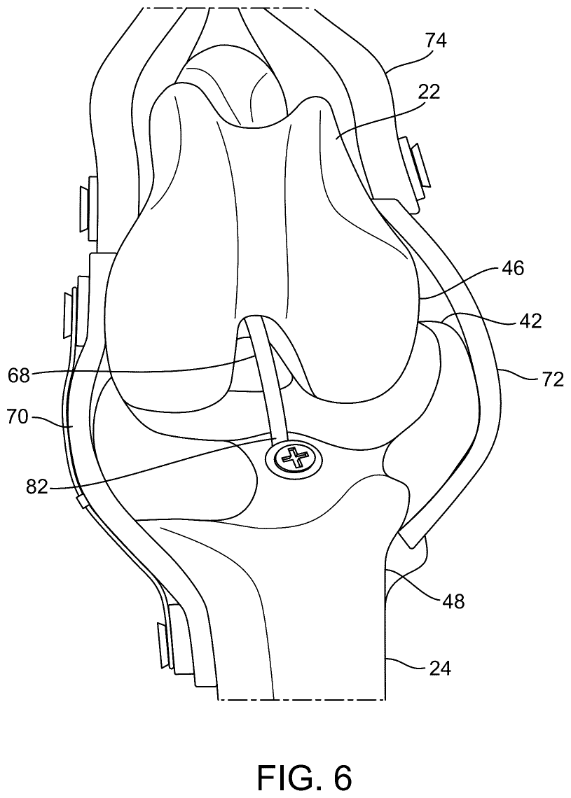

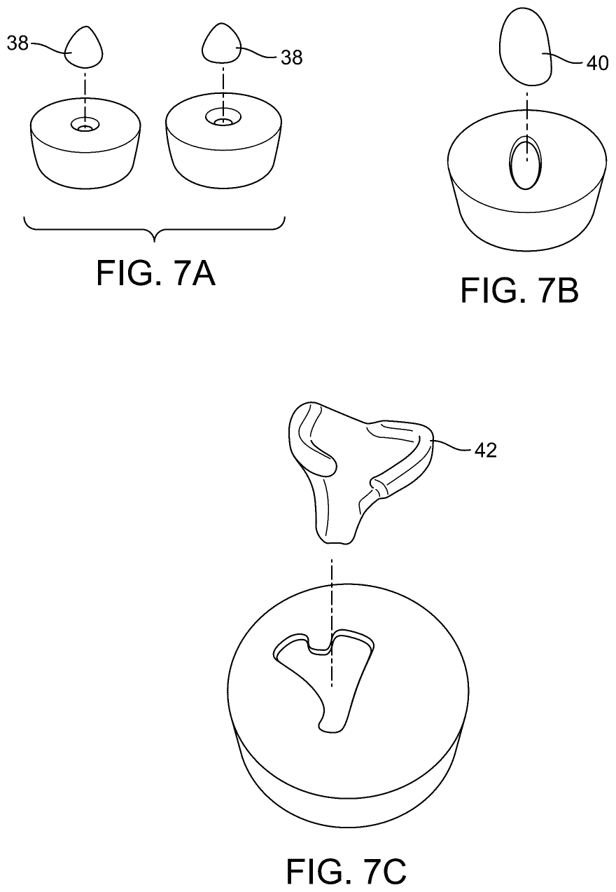

FIGS. 6 and 7 illustrate various steps and techniques associated with a method of manufacturing a stifle 10 in accordance with various embodiments of the present general inventive concept. In various example embodiments, a replica tibia member 24, replica fibula member 26, and replica femur member 22 may be provided. For example, in various embodiments, plastic medical training models of tibia, fibula, and femur are provided, of the type commonly manufactured and sold by the “Sawbones USA” company under the “SAWBONES®” trademark. It will be recognized that numerous other brands and types of replica tibia, fibula, and femur members are available and may be used without departing from the spirit and scope of the present general inventive concept. Furthermore, it will be recognized that, though not preferred, natural tibia, femur, and/or fibula, as opposed to replicas, may be used without departing from the spirit and scope of the present general inventive concept.

Upon provision of the above-discussed tibia member 24, fibula member 26, and femur member 22, a cavity 56 is formed for receipt of the above-discussed adjustable connection 44 to allow adjustment of tension between the tibia member 24 and femur member 22 as discussed above. For example, in various embodiments, the cavity 56 may be formed as by drilling, etching, excavating, or the like, on the proximolateral side of the femur member 22, including a bore through the distal end 46 of the femur member 22 for the above-discussed cord 68 to go through and attach to the proximal end 48 of the tibia member 24. The adjustable connection 44 may be assembled within the cavity 56, and the cord 68 may be fed through the femur member 22 distal end 46 and secured to the tibia member 24.

With reference to FIGS. 7A-7C, a set of silicon molds 84, 86, 88 are provided forming appropriate negative spaces for forming replica fibula members 38, patella member 40, and menisci member 42. Using the pre-made silicone molds, smooth cast is poured to make the replica fibula members 38, patella member 40, and menisci member 42. Once the smooth cast is cured, epoxy may be painted in the patellar groove on the distal end 46 of the femur member 22, on the patella member 40, on femoral condyle portions of the femur member 22, and on the menisci member 42, in order to provide smooth surfaces to these portions. The epoxy and smooth cast may be allowed to cure, preferably for at least 24 hours.

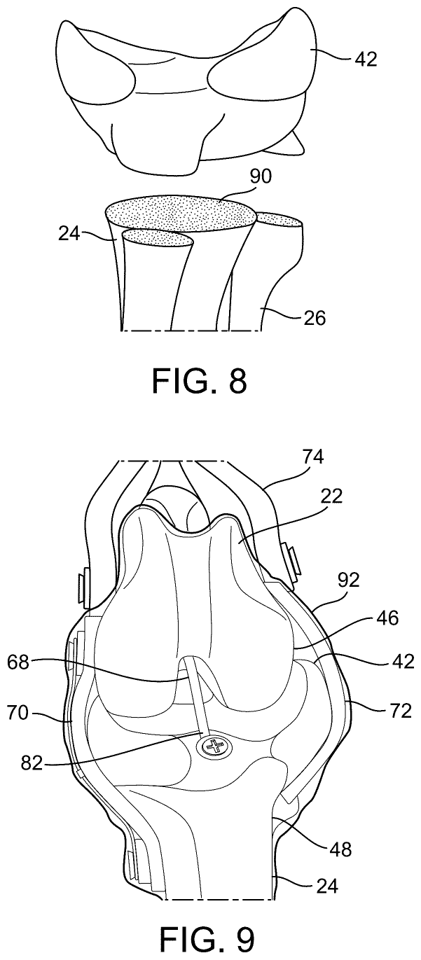

As shown in FIG. 8, the menisci member 42 may be attached to the tibia member 24. To attach the menisci member 42, the proximal end 48 of the tibia member 42 may be ground to a substantially flat surface 90. The menisci member 42 may then be secured to the flat surface 90 as by epoxy, adhesive, or other suitable fastener. One suitable epoxy is of the “metal set” type used to form epoxy welds in metal surface, such as the type manufactured and sold using the “JB WELD®” trademark. However, those of skill in the art will recognize other substances that may be used without departing from the spirit and scope of the present general inventive concept. Additional epoxy may be used to reinforce attachment of the fibula member 26 to the tibia member 24 and the fabella members 38 to the caudodistal aspect of the femur member 22. The epoxy may then be allowed to cure, again preferably for at least 24 hours.

The above-discussed first and second ligaments 70, 72 and artificial tendon 74 may be formed using the above-discussed silicon-coated nylon webbing. In some embodiments, the first and second ligaments 70, 72 and the artificial tendon 74 may be formed from platinum cure silicone rubber of the type commonly sold under the “DRAGON SKIN” brand, together with nylon string and stitchable mesh layer. The stitchable mesh layer may be placed on the ends of the silicone where the screws go through. In one embodiment, the nylon string and power mesh are placed first, then the silicone is poured on top. The patella member 40 may be placed on the silicone forming the artificial tendon 74 while it is curing. The nylon string may also placed in a lattice pattern on the various ligaments 70, 72 or artificial tendon 74 while the silicone is curing.

In preferred embodiments, certain color coding is used for various components of the stifle 10 in order to allow students to observe and identify portions of the teaching model meant to represent specific anatomical features of an animal patient. For example, in various embodiments, blue silicone dye is used for the artificial tendon 74 signifying the patellar ligament of a natural canine stifle. Green silicone dye is used for the first and second ligaments 70, 72 signifying the collateral ligaments of a natural canine stifle. Red silicone dye is used for ligaments in the hip. Finally, yellow silicone dye is used for the calcanean tendon, and the nylon strings are placed longitudinally with stitchable mesh layer where the screws insert. Those of skill in the art will recognize numerous other color codes and symbolic representations which may be used to identify the various portions of the canine stifle teaching model, and which may be used to correlate such portions with anatomical features of an animal patient, and such other color codes and representations may be used in addition to, or in the alternative to, the above-described color codes without departing from the spirit and scope of the present general inventive concept.

Once the silicone forming the first and second ligaments 70, 72 and artificial tendon 74 is cured, the members may be attached to the femur member 22 and tibia member 24 at the anatomical indexes referenced above. In various embodiments, a washer or other wide-diameter rotatable fastener component may be used to prevent the screw from slipping through the ligament. To reinforce the ligament, polymer thread 76 may be applied as illustrated in a figure-of-8 pattern. Once the first and second ligaments 70, 72 and artificial tendon 74 are attached, a small screw or other suitable fastener may be used to attach the cord 68 to the menisci member 40 or the tibia member 24. Preferably, the cord 68 should be attached with the adjustable connection 44 in its loosest position to allow for tightening of the adjustable connection 44 following connection. The tightness of the cord 68 may be tested by performing a cranial drawer test of the type known to one of skill in the art. Further adjustment may be made to ensure there is no cranial translation of the tibia member 24 at the tightest setting.

Once the adjustable connection 44 is set, Teflon powder may be applied generously to the articular surfaces of the tibia member 24 and fibula member 26 in such a manner that the Teflon powder approximately replicates the synovial joint fluid of a natural, healthy canine stifle. As shown in FIG. 9, a substantially flexible membrane 92, such as plastic wrap, rubber encapsulation, or the like, may be provided encapsulating the distal end 46 of the femur member 22 and proximal end 48 of the tibia member 24 to approximately replicate the synovial joint capsule of a natural, healthy canine stifle.

To form the above-discussed hip muscle portion 30, thigh muscle portion 32, calf muscle portion 34 and foot portion 38, premade silicone molds may be provided forming the shape of various muscles of a natural canine leg. Suitable flexible mold material, such as for example “flex foam,” may be poured into the molds. The molds may be allowed to cure, whereupon the replica muscles may be attached to the replica bones by a suitable fastener or adhesive. The replica muscles may be shaped as needed. A cotton bandage roll and vet wrap may be used to surround the replica muscles and protect the muscles and ligaments from the silicone that will be used as the skin, as well as to compress the replica muscles to a more anatomically correct position and feel. A resilient fabric layer, such as for example nylon “pantyhose” or “stocking” material, may be used to cover the replica muscles in position along the associated bones.

In various embodiments, flexible silicone, such as for example “Ecoflex 30” silicone mixed with brown silicone dye, are applied as an outer layer of silicone for the above-discussed hip muscle portion 30, thigh muscle portion 32, calf muscle portion 34 and foot portion 38. It will be recognized that the flexible silicone may, in various embodiments, be selected to approximate the appearance and texture of the skin of a natural canine leg. In preferred embodiments, three to four layers of uncured silicone are applied before the uncured silicone is formed with hair texture. Each layer is permitted to cure prior to an additional layer being applied. The hair texture may be made by adding brown silicone dye to silicone caulk and painting it on the existing silicone layer with a paintbrush.

Once cured, the top of the fabric layer encapsulating the artificial muscle portions of the stifle 10 may be trimmed near the hip muscle portion 30, and an inverting suture pattern may be used to close the hip muscle portion 30. To access the adjustable connection 44, a small window may be cut in the medial aspect of the thigh muscle portion 32. A continuous suture pattern may be used to clean up the edges and attach the silicone skin to the foam muscles around the window. As a final addition, matte black nail polish may be applied to the toenails of the metatarsal members 28 to provide a more realistic appearance to the stifle 10.

From the foregoing description, it will be recognized that a canine stifle teaching model and method of manufacture have been provided which allow for the construction of a teaching model which may be adjusted to resemble a canine stifle exhibiting RCCL, and which may also be adjusted to resemble a healthy canine stifle. Thus, students observing and interacting with the canine stifle teaching model may readily interact with the teaching model without fear or apprehension of inflicting any pain, discomfort, or inconvenience upon a live animal patient.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. An animal stifle teaching model comprising:
a tibia member, a fibula member, and a femur member assembled in anatomical spatial relationship to one another;
a plurality of ligament members extending among the tibia member, fibula member, and femur member to restrain the tibia member, fibula member, and femur member in the anatomical spatial relationship; and
an adjustment mechanism configured for selective adjustment to loosen and tighten at least one of the plurality of ligament members.

2. The animal stifle teaching model of claim 1, the adjustment mechanism comprising a cord extending from a first one of the tibia member and the femur member and secured to a second one of the tibia member and the femur member.

3. The animal stifle teaching model of claim 2, the adjustment mechanism further comprising a tightening device secured in relation to the tibia member or the femur member and configured to draw a portion of the cord toward the first one of the tibia member and the femur member.

4. The animal stifle teaching model of claim 3, the tightening device comprising a first hub secured to the first one of the tibia member and the femur member, and a threaded shaft received within a threaded bore defined by the first hub.

5. The animal stifle teaching model of claim 4, the tightening device further comprising a swivel connector secured to an end of the threaded shaft and to an end of the cord opposite the second one of the tibia member and the femur member.

6. The animal stifle teaching model of claim 5, wherein the tibia member further includes a menisci member fixed at a proximal end of the tibia member.

7. The animal stifle teaching model of claim 6, the cord extending from the femur member and secured to the menisci member.

8. The animal stifle teaching model of claim 7, the tightening device being at least partially disposed in a cavity defined by the femur member.

9. The animal stifle teaching model of claim 8, at least a portion of the cord extending along a through bore defined between the cavity and a distal end of the femur member.

10. The animal stifle teaching model of claim 9, wherein the first hub of the tightening device is fixed in relation to the femur member within the cavity.

11. The animal stifle teaching model of claim 10, the tightening device further comprising a second hub secured to the femur member within the cavity, the second hub defining a threaded bore in coaxial alignment with the threaded bore of the first hub.

12. The animal stifle teaching model of claim 11, wherein the threaded shaft is threadably received within both the threaded bore defined by the first hub and the threaded bore defined by the second hub, whereby rotation of the threaded shaft in relation to the first and second hubs results in translation of at least a portion of the cord toward or away from the distal end of the femur.

13. The animal stifle teaching model of claim 12, wherein the threaded shaft extends along a long dimension of the femur member.

14. The animal stifle teaching model of claim 13, the tightening device further comprising a handle fixed along a portion of the threaded shaft and configured to permit rotation of the threaded shaft in relation to the first and second hubs.

15. The animal stifle teaching model of claim 14, the handle comprising at least one wheel extending in a plane orthogonal to a central axis of the threaded shaft.

16. The animal stifle teaching model of claim 15 further comprising a patella member disposed along a front side of the femur member proximate an interface between the distal end of the femur and the proximal end of the tibia member.

17. The animal stifle teaching model of claim 16 further comprising a first artificial ligament at least partially securing the patella member in relation to the femur member.

18. The animal stifle teaching model of claim 17, the first artificial ligament further at least partially securing the patella member in relation to the tibia member.

19. The animal stifle teaching model of claim 18 further comprising a second artificial ligament at least partially securing a medial side of the femur member in relation to a medial side of the tibia member.

20. The animal stifle teaching model of claim 19 further comprising a third artificial ligament at least partially securing a lateral side of the femur member in relation to a lateral side of the tibia member.
